(19) United States
(12) Patent Application Publication
(10) Pub. No.: US 2012/0267317 A1
(43) Pub. Date: Oct. 25, 2012

(54) DIFFUSION INSERT FOR MEMBRANE ANALYSIS, KIT, CELL, AND DIFFUSION METHOD

(75) Inventors: Youssef Lboutoune, Besancon (FR); Philippe Humbert, Orans (FR); Delphine Binda, Auxon Dessous (FR); Lionel Pazart, Besancon (FR)

(73) Assignees: CENTRE HOSPITALIER UNIVERSITAIRE, Besancon (FR); UNIVERSITE DE FRANCHE-COMTE, Besancon (FR)

(21) Appl. No.: 13/500,943

(22) PCT Filed: Oct. 7, 2010
(86) PCT No.: PCT/FR2010/000677

§ 371 Date: Jul. 9, 2012

(30) Foreign Application Priority Data
Oct. 9, 2009 (FR) 09/04842

(51) Int. Cl. B01D 35/30; B01D 65/10

(52) U.S. Cl. 210/741; 210/232

(57) ABSTRACT

A diffusion insert (1) for a membrane (5), includes a cup (2) defining a donor compartment (20) receiving a donor solution, the base thereof defining an axial port (22) sealed by the membrane (5), a clamping element (3) to pin down the membrane (5), an element for axially locking (4) the clamping element (3), a deformation element (6) capable of deforming the membrane (5) and of protecting the lateral movement directly tangential to the deformation element (6), characterized in that the insert includes a return element (7) for deforming and radially stretching the membrane (5) in a controlled manner. A kit, a cell, a diffusion unit, and a diffusion method for implementing the diffusion insert are also disclosed.

### TECHNICAL FIELD

This invention relates to a diffusion insert for membrane analysis, a kit, a cell, a unit and a diffusion method that make it possible in particular to take transmembrane penetration measurements.

The expression “membrane analysis” is defined as any type of analysis in or through membranes such as in particular the penetration of molecules or substances in or through a membrane. Such membranes can be artificial or natural, such as, for example, epithelia that come from any type of living organism, biological or not, and cutaneous or not. More particularly, the expression “molecules or substances” is used for designating any natural, synthetic or semi-synthetic molecule, as well as groups of molecules that are not necessarily identical, whereby these molecules are in a liquid, semi-liquid, semi-solid, gaseous or vapor phase. The expression “molecules or substances” is also used to designate any biological agent such as viruses, toxins, bacterial debris, cellular mediators, chemokines, cytokines, or else growth factors.

### PRIOR ART

The diffusion cells such as the Franz cells (Franz, T. J., J Invest Dermatol, 64: 190-195; 1975) are commonly used, in particular for determining the cutaneous penetration of exogenic substances. The Franz cells primarily consist of a donor compartment that is superimposed on a receptor compartment, with the donor and receptor compartments being separated by a barrier that is formed by a cutaneous membrane. The donor compartment is designed to accommodate a donor solution that contains the molecules that are to be studied, and the receptor compartment is designed to accommodate a receptor solution that is designed to collect what will have passed through the cutaneous membrane. In a known manner, the donor and receptor compartments comprise circular grooves, facing one another, provided in the thickness of their walls that are designed to be in contact with the cutaneous membrane. These circular grooves are able to accommodate the periphery of the cutaneous membrane and a ring that locks the cutaneous membrane so as to stretch it between the donor and receptor compartments. The thus stretched and locked cutaneous membrane has a “useful” surface that can then be exposed to molecules placed in the donor solution. At regular time intervals, the receptor solution is sampled so as to meter the molecules that have passed through the cutaneous membrane, and a new receptor solution is then substituted for it. To do this, the receptor compartment is provided with one or more pipes that allow the supply and the sampling of the receptor solution.

By means of this technique, the metering of substances that are present in the sampled receptor solution makes it possible both to determine the quantity of molecules that have passed through the cutaneous membrane and the penetration flow expressed in terms of nanogram/cm²/hour.

In practice, before using the Franz cells for measuring the cutaneous penetration, the following different successive stages are initiated:

a) Skin obtained from post-surgical waste (operating room) is recovered,

b) The recovered skin is degreased by eliminating the adipose tissue (hypodermal layer),

c) The thickness of the skin strips is adjusted by using a dermatome that makes it possible to obtain a cutaneous membrane of calibrated thickness,

d) Circular cross-sections that have a predetermined diameter are cut out,

e) The thickness of each cutaneous membrane is controlled.

Between stages b) and c), the skin strips can be preserved—frozen at a temperature of −20° C. for a period of 6 to 12 months. Once stage e) is carried out, the circular cutaneous membranes, with a predefined thickness, can be individually deposited on a Franz cell. The deep face of the dermis is oriented toward the receptor solution that is provided in the receptor compartment and is supposed to replace the interstitial liquid of the skin. The assembly thus obtained is kept in position by means of a clamp that is suitable for tightening the donor compartment against the receptor compartment, thus pinning down the cutaneous membrane that is held by the ring. The unit is allowed to stand for 90 to 120 minutes so as to attain equilibrium with the environment or the surrounding atmosphere. The integrity of the cutaneous membrane is finally verified by means of a Tewameter before the implementation of the penetration test per se.

These operations for preparation and assembly are tedious to implement, repetitive, and require much handling time, which proportionately lengthens the time periods for making these analyses.

In addition, it is common, during the preparation of measurements, that an air bubble forms, located below the cutaneous membrane. When the air bubble is detected by the operator, it is to be evacuated from the surface of the cutaneous membrane by making the diffusion cell pivot to guide the air bubble toward the opening of the receptor compartment pipe. This additional stage is a source of time loss. In addition, it is a bad idea to implement in practice. When the air bubble is not detected, the results of the measurement of the transmembrane penetration are inaccurate. Actually, in this case, the entire “useful” surface of the membrane is not used, and therefore the interpretation of the results is impossible.

Furthermore, during stage a) for recovery of the skin, a skin strip sample is taken from a body, comprising a measurement area that is designed to be used for the measurement of the transmembrane penetration. Before the sampling, the measurement area has an in-vivo reference surface area. During the sampling and after, the skin strip tends to retract in such a way that the surface area of the measurement area decreases to attain a first ex-vivo retracted surface area. After stage d), a stage during which a circular cross-section is cut out in the skin strip, the circular cross-section comprising the measurement area tends to retract in such a way that the surface area of the measurement area decreases again for attaining a second ex-vivo retracted surface area. Finally, once mounted on the Franz cell, the circular cross-section of the skin strip has a final measurement surface area. So as to obtain reliable diffusion results, it is essential to be able to correlate the final measurement surface area and the in-vivo reference surface area. However, the known devices do not make it possible to obtain this correlation.

The document EP0596482 describes a testing device with multiple cavities for dialysis. The multiple cavities of a lower portion are covered by a membrane, and an upper portion with complementary cavities is placed above, such that the membrane is stretched and is held by friction between the two complementary portions.

The document US2005/063862 describes a testing device with multiple cavities for diffusion. The multiple cavities of a lower portion are covered by a membrane. The membrane is smoothed and then attached by a plate with ports corresponding to the cavities. An upper portion with complementary cavities is placed above. The cavities of the lower and upper portions have corresponding conical shapes, such that the membrane is stretched and deformed. Another option makes it possible to attach the membrane and the plate to the upper portion. However, the membrane is not placed in the cup of the donor compartment.

The documents US621772 and WO2004/029338 describe a donor compartment for dialysis, in which the membrane is placed, followed by a seal and a cylindrical element that presses against the seal and attaches the membrane. The cylindrical element and the donor compartment are equipped with complementary interlocking shapes, either a threading, or a groove rib.

### DISCLOSURE OF THE INVENTION

The purpose of this invention is to eliminate these drawbacks, and the invention proposes a diffusion insert, a diffusion kit, a diffusion cell, a diffusion unit, and a diffusion method that make it possible in particular to make analyses of transmembrane penetration in a faster and easier manner while increasing the reliability of the results and making it possible to correlate the final measurement surface area and the in-vivo reference surface area so that the results that are obtained are representative and can be interpreted in a reliable and reproducible manner.

The invention first of all relates to a diffusion insert, in particular for holding a membrane, with this diffusion insert comprising at least one cup that defines an axial donor compartment that is designed to accommodate a donor solution, the cup having an overall cylindrical shape that is equipped with a radial return whose inside portion defines a radial support surface that can accommodate the support of the periphery of the membrane that is arranged in the cup, with the radial return defining at least one cylindrical axial port that is designed to be sealed by the central portion of the membrane, with the diffusion insert comprising at least:

A clamping element that can be housed in the cup, above the membrane, and that can work with the cup to clamp the periphery of the membrane,

Locking means that are arranged to lock the clamping element at least axially relative to the cup, and

A deformation element that comprises an axial deformation surface that can deform the membrane axially and radially and that can work with the clamping element to stretch the membrane at least radially relative to the clamping surface, with the deformation element being able to work with the cup to protect a radial lateral movement that is directly tangential to the deformation surface of the deformation element that is covered by the stretched membrane, noteworthy in that it comprises at least one return element that is provided between the clamping element and the locking element, elastically deformable between an “at rest” state in which it does not tend to move the clamping element away from the locking element and a “bent” state in which it tends to move the clamping element away from the locking element to stress, deform and radially stretch the membrane in a controlled manner.

This diffusion insert makes it possible to prepare a stock of membranes in advance. When an analysis is requested, a ready-to-use stock of membranes is therefore available. The preparation time of the membranes is therefore concealed, hence a time period for making transmembrane penetration analyses is considerably shortened. The preparation stages can also be concentrated in such a way as to be implemented by dedicated personnel, allowing other individuals of different qualifications the responsibility for analysis of transmembrane penetration.

The lateral movement makes possible, during the use of the insert in a diffusion cell, to avoid the air bubble problem. The results that are obtained at the end of the transmembrane penetration analysis can therefore be exploited without any suspicion of error linked to the presence of a possible air bubble.

This diffusion insert makes it possible in particular to stretch the membrane in a controlled and reproducible manner to obtain reliable measurements and interpretable results.

According to a first embodiment, the diffusion insert comprises a holding ring that defines at least the clamping element and the deformation element, with the holding ring comprising at least one lateral offset that delimits a first ring with dimensions that are greater than those of the axial port, and a second ring that is axially distant from the first ring and with dimensions that are smaller than those of the axial port for being able to pass through it, with the lower face of the first ring defining the clamping surface, and the end of the second ring being circular and continuous and defining the deformation element.

The membrane can thus be placed in such a way that its measurement surface, stretched on the deformation ring, is directly tangential to a lateral movement that makes possible the spontaneous evacuation of an air bubble that is optionally formed below the membrane during its assembly on the diffusion insert.

Advantageously, the cup and the clamping element are respectively provided with complementary interlocking forms that are designed to work with one another to form said locking means. The membrane can thus be made integral in a reliable manner with the cup between the clamping element and the cup.

The complementary interlocking forms are selected from the group that comprises at least one outside threading and one inside threading that can interlock, and at least one rib and at least one groove that can interlock.

In an advantageous manner, said locking means comprise at least one ring that is housed in the cup.

The clamping element, the locking means, the deformation element, and the return element can advantageously be formed from a single part.

The return element is advantageously formed by an elastically deformable tab, inclined relative to the axis of the diffusion insert and defined by its height r, measured in parallel to the axis of the diffusion insert, by its length R that is measured by following its slope, and by the angle θ between its height r and its length R.

The diffusion insert is easy to prepare and to use. It makes possible the preparation in advance and in the number of ready-to use membrane diffusion inserts. It nevertheless allows the preparation of diffusion inserts just before use.

The invention also relates to a diffusion kit that comprises a box that is equipped with a bottom and a cover that can be closed on one another to define at least one storage housing. This diffusion kit is noteworthy in that it contains, in its storage housing, at least one diffusion insert as described above, with the box being equipped with at least one crosspiece, able to accommodate the cup in such a way as to protect a free space between the deformation surface and the bottom of the box. The diffusion inserts can thus be preserved for storage or transport, without running the risk of the membrane deteriorating.

The diffusion kit makes it possible to store one or more diffusion inserts that are gathered together in the same box. The preparation conditions and the characteristics of the membranes held in the diffusion inserts can be summarized on a label glued to the box and making possible the quick and reliable identification of the diffusion inserts.

The invention also relates to a diffusion cell in particular for transmembrane penetration analysis, with the diffusion cell comprising at least one receptor compartment that is designed to accommodate a receptor solution, and at least one pipe connected to the receptor compartment. This diffusion cell is noteworthy in that it comprises means for attaching at least one diffusion insert as described above, with the attachment means being arranged so that the membrane is at least in contact with, or immersed in, the receptor solution, with the receptor compartment and the attachment means being arranged to provide a radial lateral free space that is tangential to the radial lateral movement of the diffusion insert.

The thus constructed diffusion cell facilitates the spontaneous evacuation of any air bubble that would possibly be formed below the membrane. In addition, this diffusion cell allows the easy and fast assembly of diffusion inserts, therefore limiting the handling time.

The bottom of the receptor compartment is advantageously arranged to exhibit an inclined profile that defines an area of maximum depth of the receptor solution. It is therefore possible to sample the receptor solution in a precise manner at the lowest point of the receptor compartment by being assured of sampling the maximum quantity of receptor solution containing the molecules to be quantified.

The diffusion cell can also comprise adjusting means that are arranged to adapt at least the space separating the bottom of the membrane based on the height of receptor solution contained in the receptor compartment. The diffusion cell can thus be used in different series of measurements of different volumes without requiring additional material. These adjusting means can also make it possible to adjust the slope of the bottom.

Finally, the invention relates to a method for measuring the transmembrane penetration of a membrane during which a diffusion insert is used as described above, noteworthy in that a return element is selected based on its retraction coefficient a (insert) and the deformation surface of the deformation element.

### BRIEF DESCRIPTION OF THE DRAWINGS

The invention is described below, by way of nonlimiting example, with reference to the accompanying drawings, in which:

FIG. 1A is a diagrammatic elevation view of a body portion comprising an area for sampling a skin strip with a measurement area that is desired to be used to measure the transmembrane penetration of the skin by means of a diffusion insert according to the invention;

FIGS. 1B to 1D are detail views illustrating the sampling stages of the membrane; the upper portion of FIG. 1B corresponds to a detail of FIG. 1A before sampling the skin strip; the bottom and top portions respectively of FIGS. 1B and 1C are identical to one another and show the skin strip after sampling; the bottom and top portions respectively of FIGS. 1C and 1D show the membrane after it is cut out from the skin strip; the median portion of FIG. 1D shows the membrane once it is mounted on the diffusion insert that is superimposed on the membrane of the bottom portion of FIG. 1B; and the bottom portion of FIG. 1D is identical to the top portion of FIG. 1B to illustrate the correlation between the surface areas of the area of measurements before sampling and during the measurement of transmembrane penetration with the diffusion insert according to the invention;

FIGS. 2A and 2B are cross-sections of a first embodiment of the diffusion insert according to the invention, with this diffusion insert comprising a return element and being shown respectively before and after tightening the membrane;

FIGS. 3A and 3B are cross-sections of a second embodiment of the diffusion insert according to the invention, with this diffusion insert comprising a return element and being shown respectively before and after tightening the membrane;

FIG. 4 is a cross-section of a diffusion kit according to the invention that comprises two diffusion inserts of FIG. 2B;

FIG. 5 is a cross-section of a diffusion cell according to the invention that comprises a diffusion insert of FIG. 2B.

### DESCRIPTION OF EMBODIMENTS

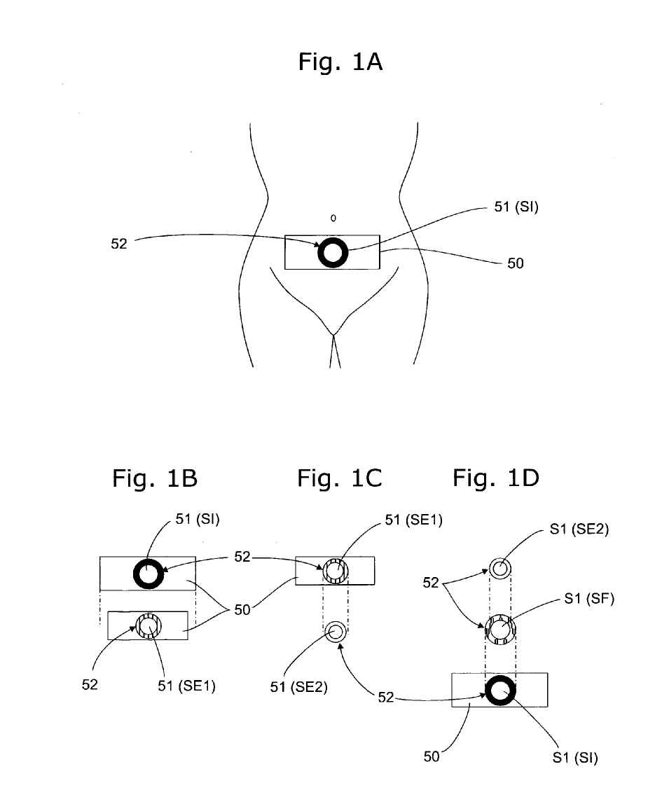

FIGS. 1A to 1D illustrate an example of an operating mode for preparation of a biological skin membrane for carrying out, above, a measurement of transmembrane penetration.

During a first stage that is illustrated by FIGS. 1A and 1B, a skin strip 50 is recovered, for example by taking a sample on a body by abdominoplasty. A skin strip 50 is selected of which one area, called measurement area 51, is designed to be used for the measurement of the transmembrane penetration and around which a cylindrical cross-section 52 of dimensions larger than those of the measurement area 51 are subsequently cut out. The difference in dimensions between the cylindrical cross-section 52 and the measurement area 51 is shown by a black area in FIG. 1A and the portion of FIG. 1B illustrating the skin strip 50 before sampling. Before the sampling of the skin strip 50, the measurement area 51 has an in-vivo reference surface area SI, indicated—for greater clarity—between parentheses in FIGS. 1A and 1B, beside the reference 51 of the corresponding measurement area. As illustrated by FIG. 1B, during and after the sampling of the skin strip 50, the latter tends to retract. The surface area of the measurement area 51 decreases to reach a first ex-vivo retracted surface area SE1, smaller than the in-vivo reference surface area SI and indicated—for greater clarity—between parentheses in FIGS. 1B and 1C, beside the reference 51 of the corresponding measurement area. The retraction of the skin strip 50 is demonstrated by the fine dot-dash lines extending from the skin strip 50 shown in the top portion of FIG. 1B and the one shown in the bottom portion of FIG. 1B.

α (in-vivo) is defined as the first retraction coefficient between the in-vivo reference surface area SI and the first ex-vivo retracted surface area SE1, defined by the ratio of the difference between [(the in-vivo reference surface area SI) and (the ex-vivo retracted surface area SE1)] by (the in-vivo reference surface area SI), namely:

α (in-vivo)=(SI−SE1)/SI

There is therefore the following: SE1=SI (1−α(in-vivo)) (Equation R1)

During a second stage that is illustrated by FIG. 1C, the circular cross-section 52 is cut out in the skin strip 50. This circular cross-section 52 has a surface area that is larger than that of the measurement area 51. During and after this cutting-out, the circular cross-section 52 tends to retract in such a way that the surface area of the measurement area 51 decreases again to reach a second ex-vivo retracted surface area SE2, smaller than the first ex-vivo retracted surface area SE1 and the in-vivo reference surface area SI. The second ex-vivo retracted surface area SE2 is indicated—for greater clarity—between parentheses in FIGS. 1C and 1D, beside the reference 51 of the corresponding measurement area.

α (intermediate), denoted α (int.), is defined as the second retraction coefficient between the first ex-vivo retracted surface area SE1 and the second ex-vivo retracted surface area SE2, defined by the ratio of the difference between [(the first ex-vivo retracted surface area SE1) and (the second ex-vivo retracted surface area SE2)] by (the first ex-vivo retracted surface area SE1), namely:

α (int.)=(SE1−SE2)/SE1

There is therefore the following: SE2=SE1 (1−α (int.)) (Equation R2)

Finally, once mounted on the Franz cell, as illustrated in the central portion of FIG. 1D, the circular cross-section 52 of the skin strip 50 is stretched by the diffusion insert 1 on which it is mounted in such a way as to exhibit a final measurement surface area SF that is larger than the second ex-vivo retracted surface area SE2 and indicated—for greater clarity—between parentheses in FIG. 1D, beside reference 51.

α (insert) is defined as the retraction coefficient between the second ex-vivo retracted surface area SE2 and the in-vivo reference surface area SI, defined by the ratio of the difference between [(the in-vivo reference surface area SI) and (the second ex-vivo retracted surface area SE2)] by (the in-vivo reference surface area SI), namely:

α (insert)=(SI−SE2)/SI=1−(SE2/SI) (Equation R3)

By combining the equations R1 and R2, the following equality is obtained:

SE2=SI (1−α (in vivo)) (1−α (int.) (Equation R4)

By combining the equations R3 and R4, the following equality is obtained:

α (insert)=1−[(1−α (in vivo)) (1−α (int.))] (Equation R5)

So as to obtain reliable diffusion results, it is essential to be able to correlate the final measurement surface area SF and the in-vivo reference surface area SI. However, the known devices do not allow this correlation, and, as presented in detail below, the diffusion insert 1. FIG. 1D makes it possible to visualize the differences in particular between the in-vivo reference surface area SI, the second ex-vivo retracted surface area SE2, and the final measurement surface area SF. Knowing the first retraction coefficient between the in-vivo reference surface area SI and the first ex-vivo retracted surface area SE1: α (in vivo), and the second retraction coefficient between the first ex-vivo retracted surface area SE1 and the second ex-vivo retracted surface area SE2: α (int.), the invention makes it possible to know the retractability coefficient of the diffusion insert: α (insert) to be used and therefore to select in a suitable manner the diffusion insert according to the invention so that the results can be interpreted and the measurements can be reproduced. Actually, based on the selected membrane, the first retraction coefficient α (in vivo) and the second retraction coefficient α (int.) are known. Consequently, it is then suitable to select the diffusion insert.

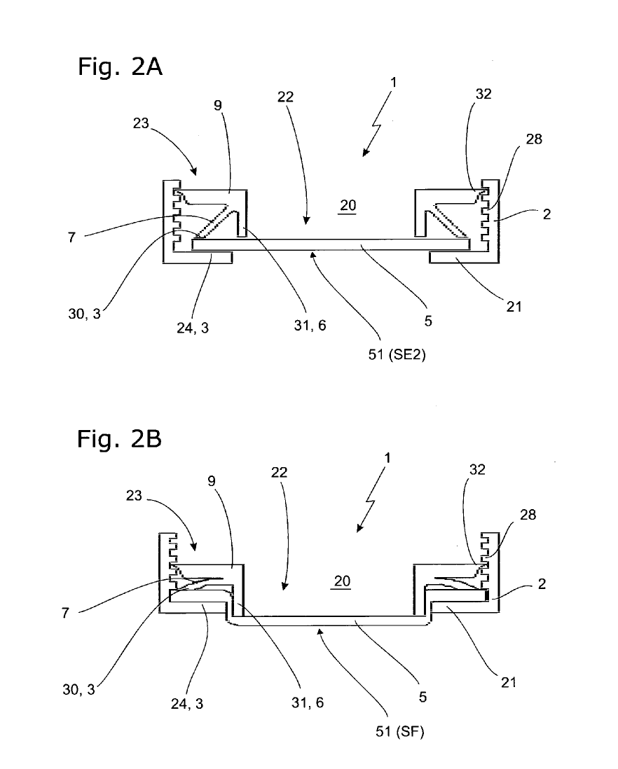

With reference to FIGS. 2A and 2B, the diffusion insert 1, according to the first embodiment, comprises a cup 2, a clamping element 3, a locking element 4, a deformation element 6, and a membrane 5. In addition, this diffusion insert 1 comprises a return element 7 that is provided between the clamping element 3 and locking means and that tends to move them away from one another so as to stretch the membrane 5 in a controlled and reproducible manner.

The cup 2 has an overall cylindrical shape and defines a donor compartment 20 that is designed to accommodate a donor solution (not shown). The cup 2 has an overall cylindrical shape that is equipped in its lower portion with a return 21 that defines a cylindrical axial port 22 whose upper face defines a support surface 24 on which the membrane 5 is placed. The axial port 22 is thus sealed by the membrane 5. The upper portion of the cup 2 comprises an opening 23 that can be equipped with a cover (not shown). The cup 2 accommodates, in the donor compartment 20, a gripping ring 9 that is designed to lock the membrane 5, to deform it, and to stretch its “useful” surface.

As presented in detail below, the gripping ring 9 forms the clamping element 3, the deformation element 6. The outside dimensions of the gripping ring 9 are smaller than the inside dimensions of the opening 23 to allow the insertion of the gripping ring 9 into the cup 2, from the top of the membrane 5 that is placed at the bottom of the cup 2.

The gripping ring 9 is equipped with a rib 32, extending toward the outside and preferably circular and designed to work with grooves 28 that are provided in the cup 2. The rib 32 is provided in an elastically deformable form so that it can deform to pass from one groove 28 to another. The gripping ring 9 can thus be moved axially in the cup 2 between an “at rest” position (shown in FIG. 2A) in which the membrane 5 is stressed only slightly or not all and in which the measurement area has a second ex-vivo retracted surface area SE2 and a “use” position (shown in FIG. 2B) in which the membrane 5 is stretched and deformed to exhibit a final measurement surface area SF. In each of these positions, the gripping ring 9 is axially locked in the cup 2 by the rib 32 that is housed in one of the grooves 28. The rib 32 and the grooves 28 thus define the locking element 4. As described subsequently with reference to FIGS. 9A and 9B, the grooves 28 and the rib 32 can be replaced by threadings.

In its lower portion, the gripping ring 9 is equipped with an axial extension that forms a deformation ring 31 that defines the deformation element 6. This deformation ring 31 has an outside diameter that is smaller than the inside diameter of the axial port 22 to make possible its insertion into the axial port 22. In addition, the deformation ring 31 has a height that is greater than the thickness of the return 21. Thus, when the gripping ring 9 is in its “use” position, housed at the bottom of the cup 2, the deformation ring 31 passes through the axial port 22 until it projects below the cup 2.

The gripping ring 9 is also equipped with a flexible tab 7, inclined relative to the axis of the gripping ring 9 and forming the return element 7. This tab 7 is preferably circular and continuous along the periphery of the gripping ring 9. In a variant embodiment, not shown, the tab is discontinuous and consists of several sections that can bend independently of one another. The tab 7 is designed to rest on the periphery of the membrane 5 for flattening it against the support surface 24 and therefore forms a pinning-down surface 30 that defines the clamping element 3. This tab 7 is elastically deformable between an “at rest” state (shown in FIG. 2A), in which the measurement area 51 has a surface area that corresponds to the second ex-vivo retracted surface area SE2, and a “bent” state (shown in FIG. 2B), in which the measurement area 51 has a surface area that corresponds to the final measurement surface area SF. To do this, a diffusion insert is selected whose tab 7 makes it possible for the connection 5 to be verified with the selected membrane.

To pin down, stretch and deform the membrane 5, the gripping ring 9 is screwed into the cup 2. This screwing has the effect of elastically deforming the tab 7 by broadening the pinning-down surface 30 and by drawing together the deformation ring 31 and the membrane 5. After its axial movement, when the gripping ring 9 is in its “use” position, the tab 7 is in its “bent” state, and the membrane 5, pinned down between the tab 7 and the support surface 24, is stretched by the broadening of the diameter of the pinning-down surface 30 that is defined by the tab 7. In addition, the membrane 5 is deformed by the support of the deformation ring 31. Thus, the membrane 5 then has a final measurement surface area SF that is flat and stretched. The tension of the membrane 5 increases with the insertion of the holding ring 3 into the cup 2. The deformation ring 31, covered by the membrane 5, is the lowest area of the diffusion insert 1 and is surrounded by a circular lateral movement that makes possible the spontaneous evacuation of a possible air bubble that is formed below the stretched “useful” surface of the membrane 5, guaranteeing the accuracy of the interpretation of the measurement as described above.

The tab 7, like any elastic return element, is characterized by stiffness. In a geometric manner, the tab 7 is characterized by its height r that is measured parallel to the axis of the gripping ring 9, by its length R that is measured by following its slope, and by the angle θ between its height r and its length R. It thus is possible to provide a pair of inserts having different characteristics, in particular different stiffnesses that make it possible to have different retraction coefficients α (insert) making it possible to respond to different possible configurations that are dependent on the angle θ, the height r and the length R, and on the stiffness of the tab 7. Each diffusion insert is therefore characterized by its retraction coefficient α (insert) and the final measurement surface area SF that is defined by the surface area of the deformation surface 31.

The particular structure of the diffusion insert 1 of FIGS. 2A and 2B also makes it possible to pre-assemble the diffusion insert 1, with the gripping ring 9 not being screwed at the bottom into the cup 2, the membrane 5 being stretched slightly or not at all, which makes it possible to extend the period during which it can be preserved before use.

In one variant embodiment, not shown, the diffusion insert comprises means for measuring physico-chemical properties of the membrane and means for characterization of the membrane. For this purpose, the locking element can be equipped with sensors or probes for measurements of, for example, humidity, temperature, pH, current, tension, or any other physical or chemical measurement.

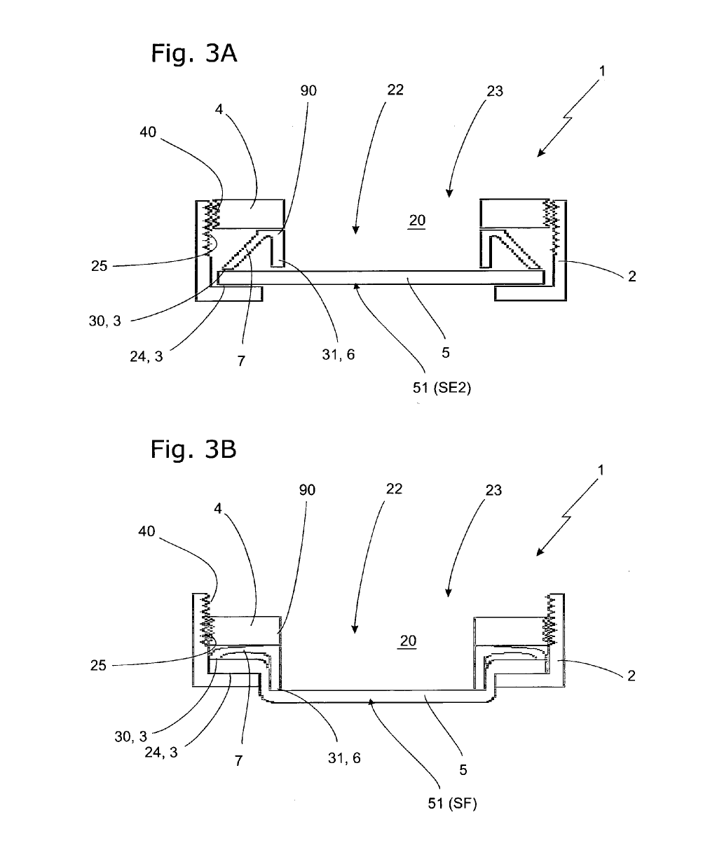

With reference to FIGS. 3A and 3B, according to a second embodiment, the diffusion insert 1 is essentially similar to the one of FIGS. 2A and 2B and comprises a clamping element 3, a locking element 4, a deformation element 6, a return element 7, and a membrane 5. It is primarily differentiated by the fact that the return element 7 is independent of the locking element 4.

In this example, the cup 2 comprises an inside threading 25, and the diffusion insert 1 comprises a locking element 4 in ring form, essentially similar to the one of FIG. 1 and equipped with an outside threading 40 that works with the inside threading 25 of the cup 2.

The diffusion insert 1 comprises a plating ring 90 that forms the clamping element 3 and the deformation element 6. The outside dimensions of the plating ring 90 are smaller than the inside dimensions of the opening 23 to allow for the insertion of the plating ring 90 into the cup 2, from the top of the membrane 5 that is placed at the bottom of the cup 2.

In its lower part, the plating ring 90 is equipped with an axial extension that forms a deformation ring 31 that defines the deformation element 6. This deformation ring 31 has an outside diameter that is smaller than the inside diameter of the axial port 22 for allowing its insertion into the axial port 22. In addition, the deformation ring 31 has a height that is greater than the thickness of the return 21. The plating ring 90 is also equipped with a flexible tab 7, forming the return element 7, similar to the one of FIGS. 8A and 8B. This tab 7 is designed to rest on the periphery of the membrane 5 for flattening it against the support surface 24 and therefore forms a pinning-down surface 30 that defines the clamping element 3. This tab 7 can be deformed elastically between an “at rest” state (shown in FIG. 3A) in which the measurement area 51 has a surface area that corresponds to the second ex-vivo retracted surface area SE2, and a “bent” state (shown in FIG. 3B) in which the measurement area 51 has a surface area that corresponds to the final measurement surface area SF.

To pin down, stretch and deform the membrane 5, the locking element 4 is screwed into the cup 2. This screwing has the effect of flattening the plating ring 90 against the membrane 5 and causing the elastic deformation of the tab 7 by broadening the pinning-down surface 30. This screwing also has the effect of drawing together the deformation ring 31 and the membrane 5. With the plating ring 90 being placed between the membrane 5 and the locking element 4, the locking element 4 can be screwed without the membrane 5 being stressed in rotation.

In the “bent” state of the tab 7, the membrane 5 is stretched by the broadening of the diameter of the pinning-down surface 30 and deformed by the support of the deformation ring 31. The deformation ring 31, covered by the membrane 5, is the lowest area of the diffusion insert 1 and is surrounded by a circular lateral movement that makes possible the spontaneous evacuation of a possible air bubble that is formed below the final stretched measurement surface SF of the membrane 5, guaranteeing the accuracy of the interpretation of the measurements as described above.

As for the diffusion insert of FIGS. 2A and 2B, the particular structure of the diffusion insert 1 of FIGS. 3A and 3B makes it possible to pre-assemble the diffusion insert 1 without putting the membrane 5 under its tension of use.

According to one variant embodiment, not shown, essentially similar to the one of FIGS. 3A and 3B, the plating ring forms the clamping element alone, without forming the deformation element. The plating ring comprises, for this purpose, an elastically deformable tab, forming the return element, whose lower end defines the pinning-down surface and whose upper end rests against the locking element. The locking element is equipped with an axial extension that forms the deformation ring. This axial extension passes through the inside diameter of the elastic tab so as to rest on the membrane and to deform it. The use of this diffusion insert is essentially similar to the one of the diffusion insert 1 of FIGS. 3A and 3B.

The diffusion inserts 1 that are described overall have cylindrical shapes. It is well understood that these diffusion inserts 1 can have an entirely different shape.

The diffusion inserts 1 according to the invention therefore make it possible to prepare, in the background, membrane samples, for example cutaneous, to be analyzed. They therefore make possible a significant time savings. In addition, by eliminating the risk of air bubbles, they guarantee—in a significant manner—the accuracy of the measurements that are taken. The membranes that are used with the diffusion kits 1 can, of course, be of an entirely different nature such as reconstructed cutaneous membranes and biological membranes of an entirely different nature that come from, for example, the intestine, the cornea, or the mucous membranes. When they are cutaneous, the membranes can come from different anatomical areas and from different donors.

When a transmembrane measurement is to be taken, the diffusion inserts 1 make it possible to carry out the analysis directly, without a waiting period during the stages for preparation and characterization of the membrane.

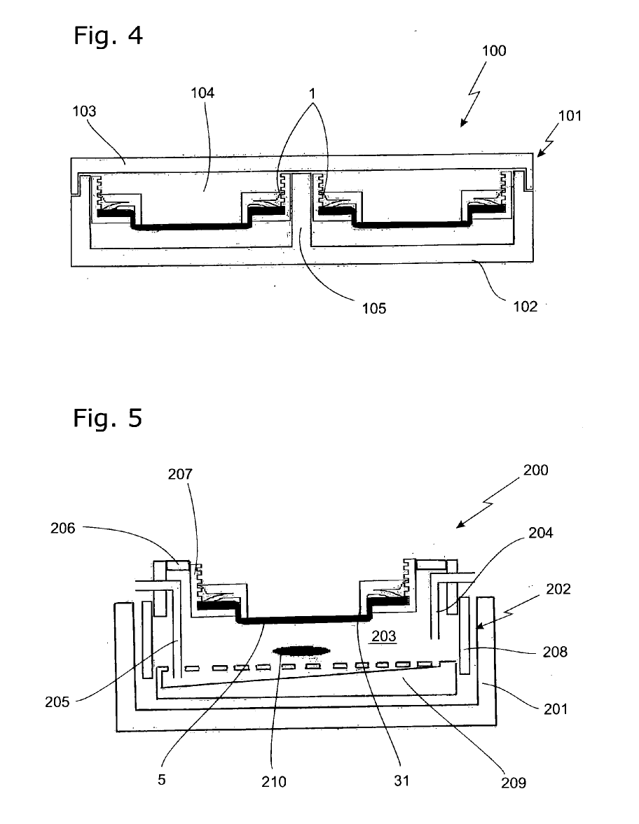

The diffusion insert 1 according to the invention can be transported or stored in a diffusion kit 100 such as the one shown in FIG. 4. In this example, the diffusion kit 100 comprises a box 101 that is equipped with a bottom 102 and a cover 103. The bottom 102 comprises a shoulder that makes it possible for the cover 103 to fit together and to delimit a closed storage housing 104. The box 101 has a general parallelepipedic shape and comprises longitudinal partitions 105 (only one of which is shown in FIG. 4) and transverse partitions (not shown). These partitions delimit individual storage spaces, for example six, in each of which a diffusion insert 1 is placed. The diffusion inserts 1 thus can be transported and/or stored without risk of deterioration. The diffusion kit 100 can also be used for transporting diffusion kits 1 before the membranes 5 are attached above. Each box 101 can advantageously bear a label (not shown) on which are summarized the identification data of the diffusion kits 1 that it contains. This label is, for example, a self-adhesive label. For example, the following will be indicated on this label: the collection date of the membrane; the anatomical area of sampling of the membrane; the phototype, the age, the gender of the donor; the thickness, the diameter, the measurement of integrity of the membrane; the recommended expiration date for use as well as a bar code that corresponds to the diffusion kit 100.

In one variant embodiment, not shown, the box comprises crosspieces, for example placed on the bottom of the box and on which the cups of the diffusion inserts are placed. These crosspieces come, for example, in the form of a ring whose thickness is greater than the prominent portion of the deformation ring in such a way as to protect, below each of the stretched membranes, a free space. The membranes thus do not run the risk of rubbing or touching the bottom of the box that would have the effect of interfering with their integrity.

In another variant embodiment, not shown, the cover of the box can be articulated relative to the bottom of the box.

The diffusion kits 100 that contain diffusion inserts 1 can be preserved for 6 to 12 months at a temperature of −20° C. They therefore make it possible to preserve and to transport, in a secure manner, diffusion inserts 1 without running the risk of degrading them. In addition, they make it possible to limit the individual handling of each diffusion insert 1, proportionately limiting the risks of deterioration and generating savings in time and personnel.

So as to take a measurement of transmembrane penetration, the diffusion kit 1 can be used within a diffusion cell 200 as illustrated by FIG. 5. In this figure, the diffusion kit 1 that is shown corresponds to the one of FIG. 1. It is well understood that other diffusion kit variants 1 can be used with the diffusion cell 200 described below.

The diffusion cell 200 comprises a chamber 201, for example a thermoregulated chamber, in which a receptor compartment 202 is placed that is designed to accommodate a receptor solution 203. The diffusion cell 200 comprises a feed pipe 204 and a sampling pipe 205 immersed in the receptor container 202 at two different locations. The feed pipe 204 makes it possible to feed the receptor solution 203 to the receptor compartment 202 before transmembrane penetration. The sampling pipe 205 makes it possible to sample all or part of the receptor solution 203 after transmembrane penetration. The diffusion cell 200 can be used in a static manner, namely in a first step by feeding the receptor solution 203 before transmembrane penetration and in a second step by sampling the receptor solution 203 after transmembrane penetration. The simultaneous presence of the feed pipe 204 and the sampling pipe 205 also makes it possible to use the diffusion cell 200 in a dynamic manner, namely continuous feeding and sampling of the receptor solution 203 during the transmembrane penetration.

In another variant embodiment, not shown, the diffusion cell comprises only a single pipe that is used successively in the feeding and sampling of the receptor solution. In this case, the diffusion cell will be used only in a static manner.

The receptor compartment 202 is delimited by lateral walls 208 and a bottom 209. In the example that is shown, the bottom 209 is arranged in an inclined manner. This particular configuration makes it possible to define an area of maximum depth of the receptor solution 203 in which the sampling pipe 205 is immersed so as to sample, as well as possible, the molecules that are obtained from the transmembrane penetration. These molecules actually have a tendency to flow into the receptor solution 203.

The receptor compartment 202 is advantageously made of transparent hydrophobic material that makes it possible to see through its lateral walls 208 and for the latter not to hold the receptor solution 203.

The diffusion cell 200 comprises means for attachment of a diffusion insert 1 that make it possible to immerse the membrane 5 in the receptor solution 203, or at least to bring the membrane 5 into contact with the receptor solution 203 while protecting a lateral free space that is tangential to the lateral movement of the diffusion insert 1. In the example that is shown, the receptor compartment 202 comprises a cover 206 that is equipped with one (or more) opening(s) that is/are (each) coupled to a sleeve 207 that extends vertically toward the inside of the receptor compartment 202. The sleeve 207 has a shape and dimensions that are suitable for accommodating a diffusion insert 1. The inside wall of the sleeve 207 can comprise a reference that makes it possible to adjust the positioning height of the diffusion insert 1 in such a way that the deformation ring 31 projects below the sleeve 207 for protecting a lateral free space through which the air bubble that is possibly formed below the membrane 5 can be evacuated spontaneously.

In one variant embodiment, not shown, the sleeve is equipped with a bottom stop up to which the diffusion insert is embedded to adjust its positioning height.

In one variant embodiment, not shown, the diffusion kit is inserted into the sleeve that forms the attachment means in such a way that the deformation ring that carries the membrane does not project below the free end of the sleeve. In this case, the free end of the sleeve will be equipped with lateral windows. The diffusion kit will be inserted until the deformation ring that carries the membrane is visible in the lateral windows. Thus, the lateral windows define a lateral free space that is directly tangential to the lateral movement provided by the deformation ring around the stretched “useful” surface of the membrane. Any air bubble that would be formed below the membrane can thus be evacuated spontaneously by means of the lateral movement and the lateral free space.

The diffusion cell 200 advantageously comprises a stifling mechanism, for example a pin 210, immersed in the receptor solution 203 and driven magnetically by a rotational movement that makes it possible to ensure vigorous stifling of the receptor solution 203.

In one variant embodiment (not shown), the attachment means can comprise a plate that is carried by the lateral walls of the receptor compartment, with this plate being equipped with one (or more) opening(s). The upper face of the plate accommodates the support of the periphery of the diffusion inserts, whose deformation ring that carries the membrane is inserted into the opening in such a way as to be brought into contact with the receptor solution and to provide a lateral free space.

In another variant embodiment that is not shown, the bottom of the receptor compartment is coupled to adjusting means making it possible to adapt its height and/or its slope. In the first case, the capacity of the receptor compartment can be adapted to the quantity of receptor solution that is contained in the diffusion cell. In the second case, the slope can be modified.

The invention also relates to a diffusion unit (not shown) that comprises several diffusion cells that are arranged in an adjacent manner and that make it possible to perform transmembrane penetration tests in series. This diffusion cell comprises a receptacle in which the diffusion cells are placed. Each diffusion cell is individually connected by a sampling pipe to a recovery container. Thus, a recognized series of measurements can correspond to each diffusion cell. The diffusion cells can be fed by a single feed pipe that comprises several feed heads, each diffusion cell being coupled to a feed head.

### OPTIONS FOR INDUSTRIAL APPLICATION

The diffusion insert, the diffusion kit, and the diffusion cell according to the invention are designed in particular to be used for making analyses of penetration called transmembrane penetration analyses on membranes that the diffusion inserts use to keep stretched while a donor solution is applied to the membrane. Next, the penetration time of the donor solution and the solution that has passed through the membrane are analyzed. The membranes that are used can be artificial or natural, biological or not, and cutaneous or not.

It is well understood that the described examples are only particular illustrations and are in no case limiting of the fields of application of the invention. One skilled in the art can provide adjustments in size, shape and material to the particular embodiment without thereby exceeding the scope of this invention.

1-11. (canceled)

12. Diffusion insert (1), in particular for holding a membrane (5), with said diffusion insert (1) comprising at least one cup (2) that defines an axial donor compartment (20) that is designed to accommodate a donor solution, said cup (2) having a cylindrical shape that is equipped with a radial return (21) whose inside portion defines a radial support surface (24) that can accommodate the support of the periphery of said membrane (5) that is arranged in said cup (2), with the interior of said cup (2) comprising grooves (28), the upper portion of said cup (2) comprising an opening (23), said radial return (21) defining at least one cylindrical axial port (22) that is designed to be sealed by the central portion of said membrane (5), with said diffusion insert (1) comprising at least one gripping ring (9) that is designed to lock the membrane (5), to deform it, and to stretch its “useful” surface, whereby said gripping ring (9) has outside dimensions that are smaller than the inside dimensions of said opening (23), said gripping ring (9) being equipped with an elastically deformable rib (32), extending toward the outside and preferably circular and designed to work with grooves (28), the gripping ring (9) also being equipped, in its lower portion, with an axial extension that forms a deformation ring (31) that has an outside diameter that is smaller than the inside diameter of the axial port (22) and a height that is greater than the thickness of said return (21), with said deformation ring (31) being designed to pass through the axial port (22) until it projects below the cup (2) when the gripping ring (9) is in its “use” position, housed at the bottom of the cup (2), characterized in that said gripping ring (9) is also equipped with a flexible tab (7), inclined relative to the axis of said gripping ring (9); said tab (7) is designed to rest on the periphery of the membrane (5) to flatten it against the support surface (24) and forming a pinning-down surface (30) that defines a clamping element (3), with said tab (7) being elastically deformable between an “at rest” state in which it does not tend to move said clamping element (3) away from said rib (32) and a “bent” state in which it tends to move said clamping element (3) away from said rib (32) to stress, deform and radially stretch said membrane (5) in a controlled manner.

13. Diffusion insert (1), in particular for holding a membrane (5), with said diffusion insert (1) comprising at least one cup (2) that defines an axial donor compartment (20) that is designed to accommodate a donor solution, said cup (2) having a cylindrical shape that is equipped with a radial return (21) whose inside portion defines a radial support surface (24) that can accommodate the support of the periphery of said membrane (5) that is arranged in said cup (2), the interior of said cup (2) comprising a first threading (28), the upper portion of said cup (2) comprising an opening (23), said radial return (21) defining at least one cylindrical axial port (22) that is designed to be sealed by the central portion of said membrane (5), with said diffusion insert (1) comprising at least one gripping ring (9) that is designed to lock the membrane (5), to deform it and to stretch its “useful” surface, with said gripping ring (9) having outside dimensions that are smaller that the inside dimensions of said opening (23), said gripping ring (9) being equipped with a second threading (32), extending toward the outside, preferably circular and designed to work with the first threading (28), the gripping ring (9) also being equipped, in its lower portion, with an axial extension that forms a deformation ring (31) that has an outside diameter that is smaller than the inside diameter of the axial port (22) and a height that is greater than the thickness of said return (21), with said deformation ring (31) being designed to pass through the axial port (22) until it projects below the cup (2) when the gripping ring (9) is in its “use” position, housed at the bottom of the cup (2), wherein said gripping ring (9) is also equipped with a flexible tab (7), inclined relative to the axis of the gripping ring (9); said tab (7) is designed to rest on the periphery of the membrane (5) to flatten it against the support surface (24) and forming a pinning-down surface (30) that defines a clamping element (3), with said tab (7) being elastically deformable between an “at rest” state in which it does not tend to move said clamping element (3) away from said threading (32) and a “bent” state in which it tends to move said clamping element (3) away from said threading (32) to stress, deform and radially stretch said membrane (5) in a controlled manner.

14. Diffusion insert (1), in particular for holding a membrane (5), with said diffusion insert (1) comprising at least one cup (2) that defines an axial donor compartment (20) that is designed to accommodate a donor solution, said cup (2) having a cylindrical shape that is equipped with a radial return (21) whose inside portion defines a radial support surface (24) that can accommodate the support of the periphery of said membrane (5) that is arranged in said cup (2), with the interior of said cup (2) comprising an inside threading (25), the upper portion of said cup (2) comprising an opening (23), said radial return (21) defining at least one cylindrical axial port (22) that is designed to be sealed by the central portion of said membrane (5), with said diffusion insert comprising at least one locking element (4) that is in the shape of a ring and that is equipped with an outside threading (40), designed to work with the inside threading (25), with said diffusion insert (1) comprising at least one gripping ring (90) that is designed to lock the membrane (5), to deform it, and to stretch its “useful” surface, whereby said gripping ring (90) has outside dimensions that are smaller than the inside dimensions of said opening (23), the gripping ring (90) also being equipped, in its lower portion, with an axial extension that forms a deformation ring (31) that has an outside diameter that is smaller than the inside diameter of the axial port (22) and a height that is greater than the thickness of said return (21), with said deformation ring (31) being designed to pass through the axial port (22) until it projects below the cup (2) when the gripping ring (90) is in its “use” position, housed at the bottom of the cup (2), wherein it is also equipped with a flexible tab (7), inclined relative to the axis of the gripping ring (90); said tab (7) is designed to rest on the periphery of the membrane (5) to flatten it against the support surface (24) and forming a pinning-down surface (30) that defines a clamping element (3), with said tab (7) being elastically deformable between an “at rest” state in which it does not tend to move said clamping element (3) away from said locking element (4) and a “bent” state in which it tends to move said clamping element (3) away from said locking element (4) to stress, deform and radially stretch said membrane (5) in a controlled manner.

15. Diffusion insert (1), in particular for holding a membrane (5), with said diffusion insert (1) comprising at least one cup (2) that defines an axial donor compartment (20) that is designed to accommodate a donor solution, said cup (2) having a cylindrical shape that is equipped with a radial return (21) whose inside portion defines a radial support surface (24) that can accommodate the support of the periphery of said membrane (5) that is arranged in said cup (2), with said radial return (21) defining at least one cylindrical axial port (22) that is designed to be sealed by the central portion of said membrane (5), with said diffusion insert (1) comprising at least:
A clamping element (3) that can be housed in said cup (2), above said membrane (5), and that can work with said cup (2) to clamp the periphery of said membrane (5),
Locking means that are arranged to lock said clamping element (3) at least axially relative to said cup (2), and
A deformation element (6) that comprises an axial deformation surface (31) that can deform said membrane (5) axially and radially and that can work with said clamping element (3) to stretch said membrane (5) at least radially relative to said clamping surface (30), with said deformation element (6) being able to work with said cup (2) to protect a radial lateral movement that is directly tangential to said deformation surface (31) of said deformation element (6) that is covered by said stretched membrane (5), wherein it comprises at least one return element (7) that is provided between said clamping element (3) and said locking element (4), elastically deformable between an “at rest” state in which it does not tend to move said clamping element (3) away from said locking element (4) and a “bent” state in which it tends to move said clamping element (3) away from said locking element (4) to stress, deform and radially stretch said membrane (5) in a controlled manner.

16. Diffusion insert (1) according to claim 15, wherein said diffusion insert (1) comprises a holding ring (8) that defines at least said clamping element (3) and said deformation element (6), with said holding ring (8) comprising at least one lateral offset that delimits a first ring with dimensions that are greater than those of said axial port (22), and a second ring that is axially distant from said first ring and with dimensions that are smaller than those of said axial port (22) for being able to pass through it, with the lower face of said first ring defining said clamping surface (30), and the end of said second ring being circular and continuous and defining said deformation element (31).

17. Diffusion insert (1) according to claim 15, wherein said cup (2) and said clamping element (3) are respectively equipped with complementary interlocking forms (25, 40; 28, 32) that are designed to work with one another to form said locking means.

18. Diffusion insert (1) according to claim 17, wherein said complementary interlocking forms (25, 40) are selected from the group that comprises at least one outside threading (40) and one inside threading (25) that can interlock, and at least one rib (32) and at least one groove (28) that can interlock.

19. Diffusion insert (1) according to claim 12, wherein said locking means comprise at least one ring (4) that is housed in said cup (2).

20. Diffusion insert (1) according to claim 15, wherein said clamping
element (3), said locking means, said deformation element (6) and said return element (7) are formed from a single part.

21. Diffusion insert (1) according to claim 15, wherein said return element is formed by an elastically deformable tab (7) that is inclined relative to the axis of said diffusion insert (1) and defined by its height r, measured in parallel to the axis of said diffusion insert (1), by its length R that is measured by following its slope and by the angle θ between its height r and its length R.

22. Diffusion kit (100) comprising a box (101) that is equipped with a bottom (102) and a cover (103) that can be closed on one another to define at least one storage housing (104), wherein it contains, in its storage housing (104), at least one diffusion insert (1) according to claim 12, whereby said box (101) is equipped with at least one crosspiece, able to accommodate said cup (2) in such a way as to protect a free space between said deformation surface (27; 31) and said bottom (102) of said box (101).

23. Diffusion cell (200) in particular for transmembrane penetration analysis, with said diffusion cell (200) comprising at least one receptor compartment (202) that is designed to accommodate a receptor solution (203), at least one pipe (204, 205) that is connected to said receptor compartment (202), wherein it comprises means (207) for attachment of at least one diffusion insert (1) according to claim 12, with said attachment means (207) being arranged so that said membrane (5) is at least in contact with said receptor solution (203), said receptor compartment (202) and said attachment means (207) being arranged to provide a radial lateral free space that is tangential to said radial lateral movement of said diffusion insert (1).

24. Diffusion cell (200) according to the claim 23, wherein the bottom (209) of said receptor compartment (202) is arranged to exhibit an inclined profile that defines an area of maximum depth of said receptor solution (203).

25. Diffusion cell (200) according to claim 23, wherein it comprises adjusting means that are arranged for adapting at least the space that separates said bottom (209) of said membrane (5) based on the height of the receptor solution (203) that is contained in said receptor compartment (202).

26. Method for measuring the transmembrane penetration of a membrane (5) during which a diffusion insert (1) according to claim 12 is used in particular to hold and stretch said membrane (5), wherein a return element (7) is selected based on its retraction coefficient a (insert) and said deformation surface (27; 31) of said deformation element (6).

27. Diffusion insert (1) according to claim 16, wherein said cup (2) and said clamping element (3) are respectively equipped with complementary interlocking forms (25, 40; 28, 32) that are designed to work with one another to form said locking means.

28. Diffusion cell (200) according to claim 24, wherein it comprises adjusting means that are arranged for adapting at least the space that separates said bottom (209) of said membrane (5) based on the height of the receptor solution (203) that is contained in said receptor compartment (202).
